(19) United States
(12) Patent Application Publication
(10) Pub. No.: US 2013/0333776 A1
(43) Pub. Date: Dec. 19, 2013

(54) CONDENSATE REMOVAL PUMP HAVING IMPROVED CHECK VALVE

(71) Applicant: SPIRAX SARCO, INC., Blythewood, SC (US)

(72) Inventors: Aaron L. FREEMAN, Elgin, SC (US); Neil J. DAVIES, Columbia, SC (US)

(21) Appl. No.: 13/916,873

(22) Filed: Jun. 13, 2013

Related U.S. Application Data
(60) Provisional application No. 61/660,209, filed on Jun. 15, 2012.

(51) Int. Cl. F16K 15/02

(52) U.S. Cl. CPC F16K 15/02
USPC 137/527; 137/565.17

(57) ABSTRACT

A check valve is provided that includes a body defining a flow path between an upstream side and a downstream side. A pivot pin is disposed within the body in the flow path, and includes a longitudinal shaft and one or more bearings rotatably coupled along at least a portion of the shaft. The check valve also includes at least one valve plate rotatably coupled with at least one of the one or more bearings to regulate fluid flow through the check valve.

### CROSS-REFERENCE TO RELATED APPLICATIONS

This patent application is a non-provisional application of co-pending U.S. Provisional Patent Application No. 61/660,209, filed Jun. 15, 2012, and entitled “CONDENSATE REMOVAL PUMP HAVING IMPROVED CHECK VALVE,” the entirety of which is hereby incorporated by reference as if set forth verbatim herein and relied upon for all purposes.

### FIELD OF THE INVENTION

The present disclosure relates generally to condensate removal systems. More specifically, the present disclosure relates to a condensate pump comprising at least one improved check valve.

### BACKGROUND

Condensate removal systems in steam piping arrangements often utilize gas pressure-driven pumps that function without electrical power. These condensate removal pumps typically have a tank with a liquid inlet and a liquid outlet. The liquid inlet and liquid outlet, which are located near the bottom of the tank, are equipped with an inlet check valve and an outlet check valve, respectively, to permit liquid flow only in the pumping direction. A pair of valves interconnected by a snap-acting linkage controls a gas motive port and a gas exhaust port.

The check valves used at the liquid inlet and liquid outlet in condensate removal pumps may be split-disc check valves (also known as “dual plate” or “split flapper” check valves). When used in a condensate removal pump, split-disc check valves cycle (i.e., fully open and close) once during each fill and discharge cycle of the pump. Because condensate removal pumps may have an expected service life of 3 to 5 million cycles, these pumps are a very demanding application for split-disc check valves. For example, it has been found that the check valve pin and spring components are quite susceptible to wear and premature failure.

### SUMMARY

The subject matter described herein recognizes and addresses disadvantages of prior art constructions and methods. The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

According to an embodiment, a check valve comprising a body defining a flow path and a pivot pin within the body in the flow path is provided. The pivot pin comprises a longitudinal shaft and one or more bearings rotatably coupled along at least a portion of the shaft. At least one valve plate is rotatably coupled with at least one of the one or more bearings to regulate fluid flow through the check valve. In one embodiment, the bearings may comprise composite graphite-metal bearings. In yet another embodiment, at least one spring may be coupled with the pivot pin over the plurality of bearings to bias the at least one valve plate toward a closed position.

According to another embodiment, a gas pressure-driven fluid pump is provided comprising a pump tank having a liquid inlet and a liquid outlet. The gas pressure-driven fluid pump also comprises a float carried within the interior of the pump tank. The float is operative to move between a low level position and a high level position. Further, the gas pressure-driven fluid pump comprises at least one check valve in fluid communication with one of the liquid inlet and the liquid outlet. The at least one check valve comprises a pivot pin. The pivot pin comprises a shaft having a reduced friction bearing arrangement.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements.

FIG. 1A is a side cross-sectional view of a pressure-driven pump which may be used with embodiments described herein with the float in the low level position.

FIG. 1B is a side cross-sectional view of the pressure-driven pump of FIG. 1A with the float moving toward, but not yet reaching, the high level position.

FIG. 1C is a side cross-sectional view of the pressure-driven pump of FIG. 1A with the float in the high level position.

FIG. 1D is a side cross-sectional view of the pressure-driven pump of FIG. 1A with the float moving toward, but not yet reaching, the low level position.

FIG. 2 is a perspective view of the upstream side of a split-disc check valve constructed in accordance with an embodiment described herein.

FIG. 3 is a perspective view of the downstream side of the split-disc check valve of FIG. 2.

FIG. 4 is an elevational view of the downstream side of the split-disc check valve of FIG. 2.

FIG. 5A is a schematic representation of the operation of a split-disc check valve in accordance with an embodiment described herein with the valve in the open position.

FIG. 5B is a schematic representation of the operation of the split-disc check valve of FIG. 5A with the valve in the closed position.

FIG. 6 is a side view of a pivot pin for a valve constructed in accordance with an embodiment described herein.

FIG. 7 is an enlarged perspective view of the downstream side of a split-disc check valve incorporating the pivot pin of FIG. 6.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

In general, various aspects relate to providing a valve comprising a pin and at least one plate which pivots about the pin to open and close the valve, wherein the pin is fitted with a plurality of bearings to reduce friction between the at least one plate and the pin and to reduce wear. The valve may be a split-disc check valve, and the bearings may be composite graphite-metal bearings, in one example. Although several preferred embodiments are described below in the context of pressure-driven condensate removal pump applications, those of skill in the art will appreciate that the subject matter described herein is not so limited. In fact, embodiments described herein may be used in any suitable application involving the use of valves.

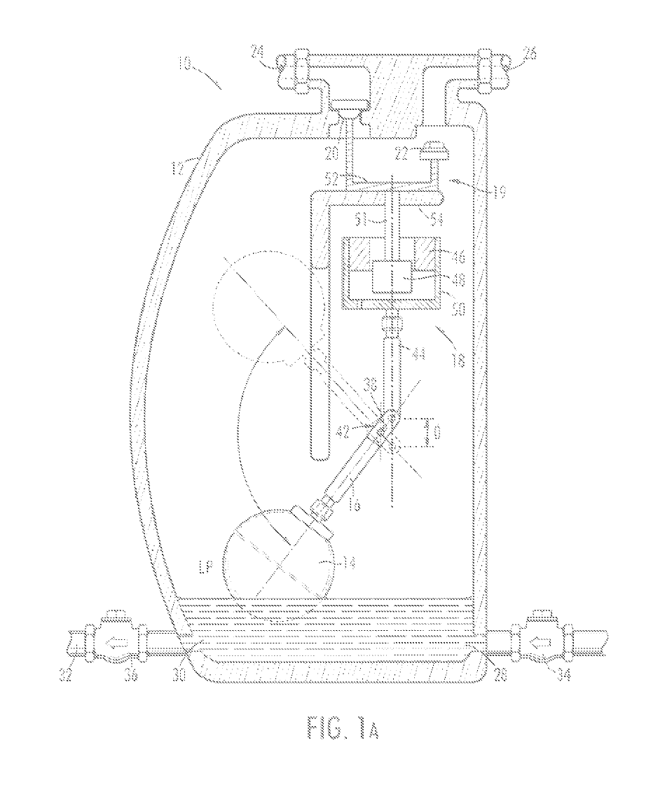

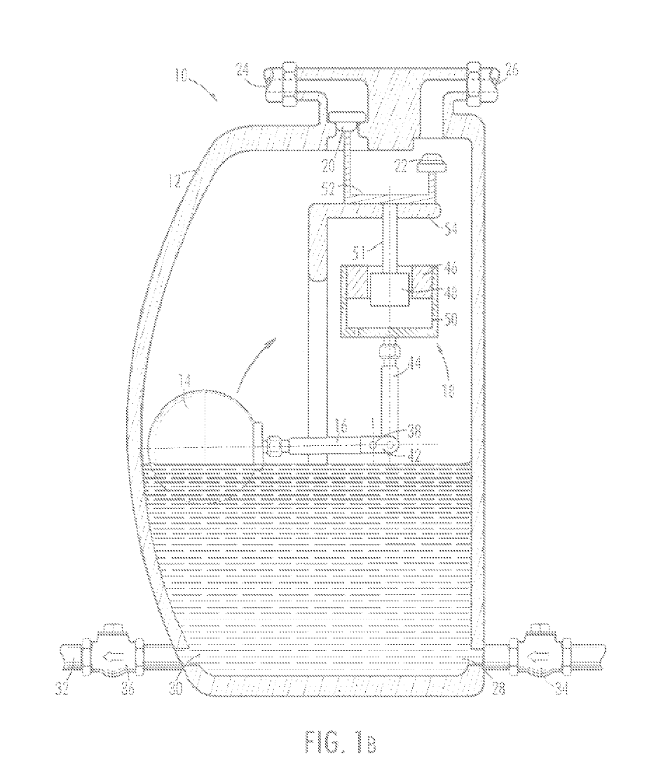

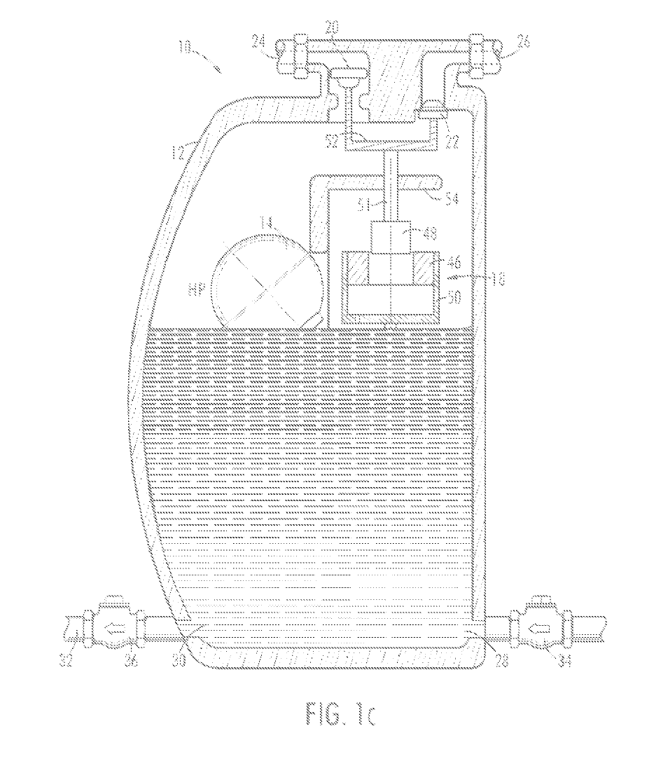

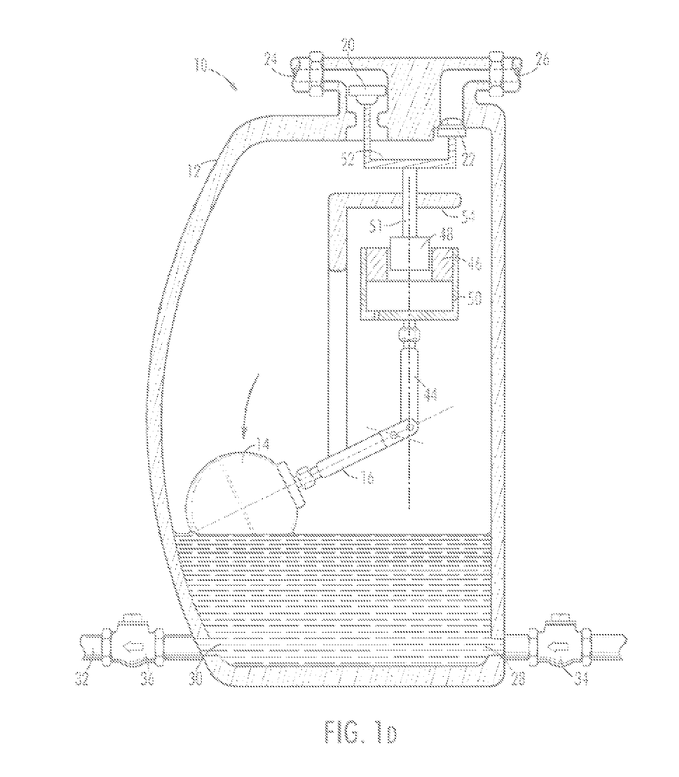

FIGS. 1A-1D illustrate a pressure driven pump 10 which may be used with certain embodiments described herein. As shown, pump 10 comprises a tank 12 defining an interior in which a float 14 may be located. Float 14 may be attached to the end of a float arm 16, which can be operatively connected to a valve control mechanism 18. Valve control mechanism 18, in turn, may control the operation of a valve assembly 19 including a motive valve 20 and an exhaust valve 22.

Valves 20 and 22, respectively, function to introduce motive gas into and exhaust gas out of the interior of tank 12 based on the position of float 14. Toward this end, a motive pipe 24 may be connected between motive valve 20 and a source of motive gas, such as a source of steam. Similarly, a balance pipe 26 may be connected between exhaust valve 22 and a suitable sink to which gas inside of tank 12 can be exhausted. In some cases, for example, balance pipe 26 can terminate such that the gas can simply exhaust to the ambient atmosphere.

As shown, tank 12 can define a liquid inlet 28 through which the liquid to be pumped may be introduced. Tank 12 can further define a liquid outlet 30 through which the liquid passes when pumped into return line 32. Respective check valves 34 and 36 are provided at liquid inlet 28 and liquid outlet 30 so that the liquid flows in only the desired direction. As described in greater detail below, check valves 34 and 36 may be constructed as split-disc check valves in embodiments described herein.

When tank 12 is emptied, float 14 can fall to the low level position LP shown in FIG. 1A. Upon reaching position LP, mechanism 18 can simultaneously switch motive valve 20 and exhaust valve 22 from motive porting to exhaust porting (e.g., in a snap over manner). During exhaust porting, exhaust valve 22 is open to allow fluid communication between the interior of tank 12 and balance pipe 26; motive valve 20, however, is closed to block fluid communication between motive pipe 24 and tank 12. It should be appreciated by one of ordinary skill in the art that various types of valves could be used for motive valve 20 and exhaust valve 22.

At the beginning of the liquid filling phase, liquid can begin flowing into tank 12 when the pressure is sufficient to overcome the pressure drop across check valve 34. If the pressure of the liquid is high enough, it can continue through check valve 36 and into return line 32. When the back pressure in return line 32 exceeds the pressure in the interior of tank 12, however, the liquid can begin to fill tank 12. As the level of the liquid rises, so does float 14. As seen in FIG. 1B, however, the positions of motive valve 20 and exhaust valve 22 do not change when float 14 is rising.

When float 14 reaches position HP, however, as shown in FIG. 1C, mechanism 18 can simultaneously switch motive valve 20 and exhaust valve 22 from exhaust porting to motive porting (e.g., in a snap over manner). During motive porting, motive valve 20 allows fluid communication between the motive pipe 24 and the interior of tank 12. Motive gas thus introduced into tank 12 can force the liquid through liquid outlet 30 and into return line 32. In contrast, exhaust valve 22 is closed during motive porting as shown. Float 14 drops along with the level of the liquid. As shown in FIG. 1D, however, the positioning of motive valve 20 and exhaust valve 22 may remain the same until float 14 reaches position LP. When float 14 eventually falls to position LP, the pumping cycle may begin again.

Further information on condensate removal systems and condensate removal pumps is provided in commonly-owned U.S. Pat. Nos. 5,938,409; 6,808,370; 6,935,844; 7,004,728; 7,048,513; 7,070,394; 7,520,731; and 7,704,053, the entire disclosures of which are incorporated by reference herein in their entireties for all purposes.

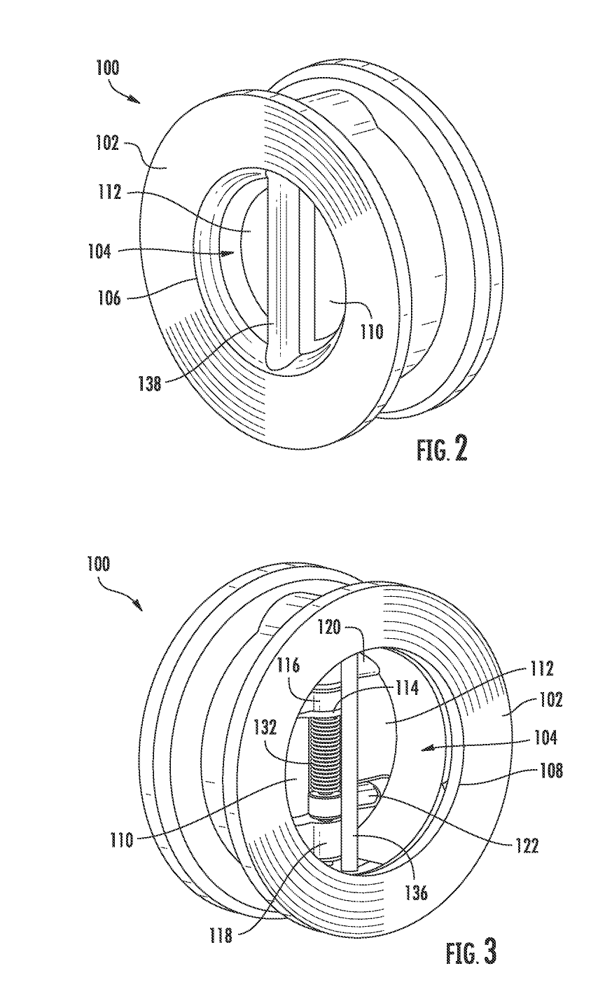

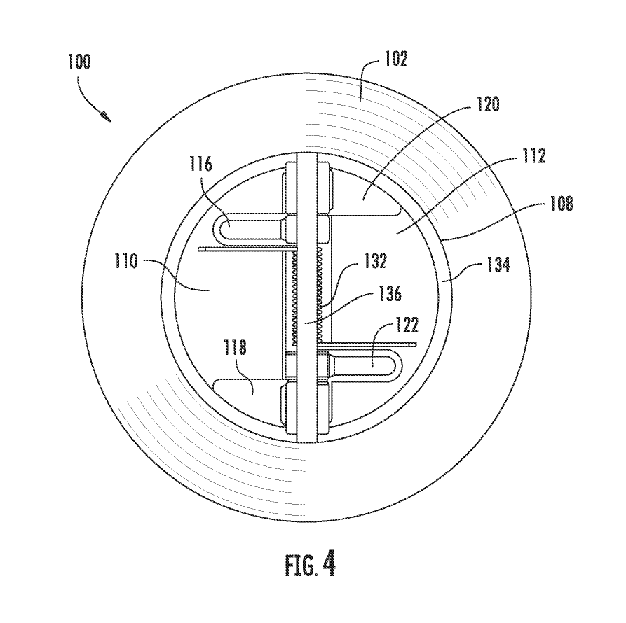

FIGS. 2 and 3 are perspective views of upstream and downstream sides, respectively, of a check valve 100 constructed in accordance with embodiments described herein. FIG. 4 is an elevational view of a downstream side of check valve 100. As shown, check valve 100 may be a split-disc check valve, although as noted above other types of valves are within the scope of described embodiments. Check valve 100 can comprise a body 102 defining a flow path 104 therethrough between an upstream side 106 and a downstream side 108. Body 102 may be formed of a suitable high strength metal, such as carbon, stainless steel, etc.

Check valve 100 can further comprise valve plates 110, 112 positioned within flow path 104 to regulate fluid flow through check valve 100. Valve plates 110, 112, which may be semicircular in many embodiments, may be rotatably coupled with a pivot pin 114. In the depicted example, the valve plates 110, 112 are disposed on diametrically opposing ends of the check valve 100. More particularly, valve plate 110 may include a pair of mounting arms 116, 118, and valve plate 112 may include a pair of mounting arms 120, 122. Mounting arms 116, 118, 120, 122 can each define an aperture therethrough which receives pivot pin 114. Both pivot pin 114, which may be fixedly connected to valve body 102, and/or plates 110, 112, which rotate about pivot pin 114, may be formed of a suitable high strength metal, such as stainless steel. As will be described in more detail below, pivot pin 114 can be equipped with a bearing arrangement that reduces friction and enhances operational life of the bearing.

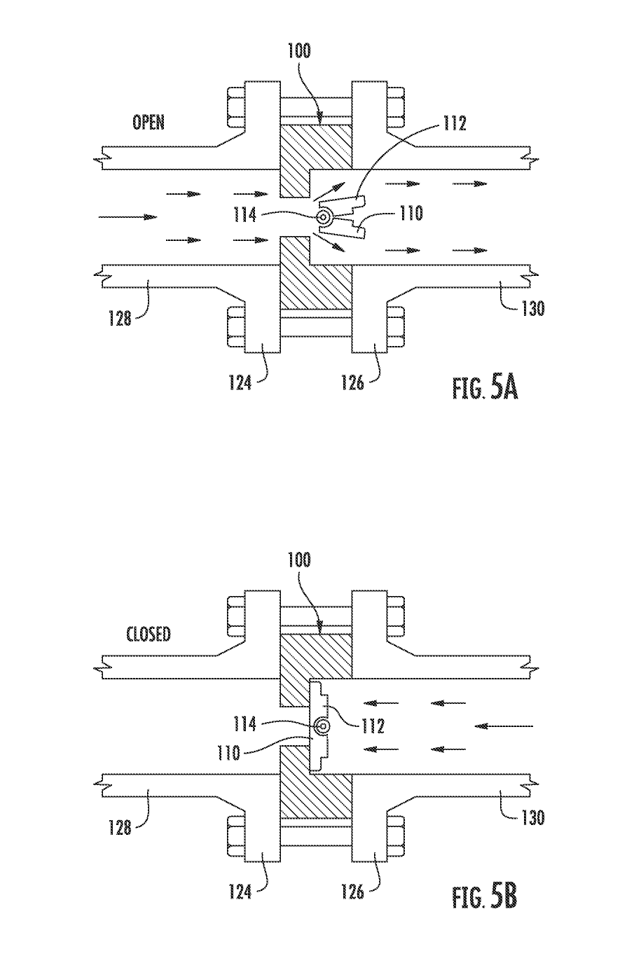

The general operation of check valve 100 is presently described with reference also to FIGS. 5A-5B. As shown, check valve 100 may be fitted between flanges 124, 126 of an upstream pipe 128 and a downstream pipe 130, respectively. During operation, a spring 132 (FIG. 4), which may be a torsion spring or similar spring, can bias valve plates 110, 112 toward the closed position shown in FIG. 5B. In one embodiment, spring 132 may be formed of a metal suitable for high temperature applications, such as a nickel-chromium alloy (e.g., Inconel-X, offered by Special Metals Corporation), although other materials may be used. Spring 132 may at least partially surround at least a portion of pivot pin 114 between mounting arms 116, 118, 120, 122. Further, in some embodiments more than one spring 132 may surround pivot pin 114. In the closed position, valve plates 110, 112 may engage a valve seat 134. In one preferred embodiment, valve seat 134 is formed of metal, although in other embodiments valve seat 134 may comprise a softer fluoroelastomer material or other material.

However, when forward flow causes the differential pressure across check valve 100 to exceed a predetermined value, either or both of valve plates 110, 112 may overcome the bias of spring 132 and move to the open position shown in FIG. 5A. A stop pin 136 (FIGS. 3 and 4) can be disposed in flow path 104 downstream of valve plates 110, 112 to stop rotation of valve plates 110, 112 about hinge pin 114. In some embodiments, body 102 may define a flow splitter 138 in flow path 104 upstream of valve plates 110, 112 (FIG. 2). Flow splitter 138 may divert fluid toward valve plates 110, 112 to reduce pressure losses in check valve 100. When the differential pressure across check valve 100 decreases below the predetermined value, spring 132 can again bias valve plates 110, 112 to the closed position to prevent reverse flow.

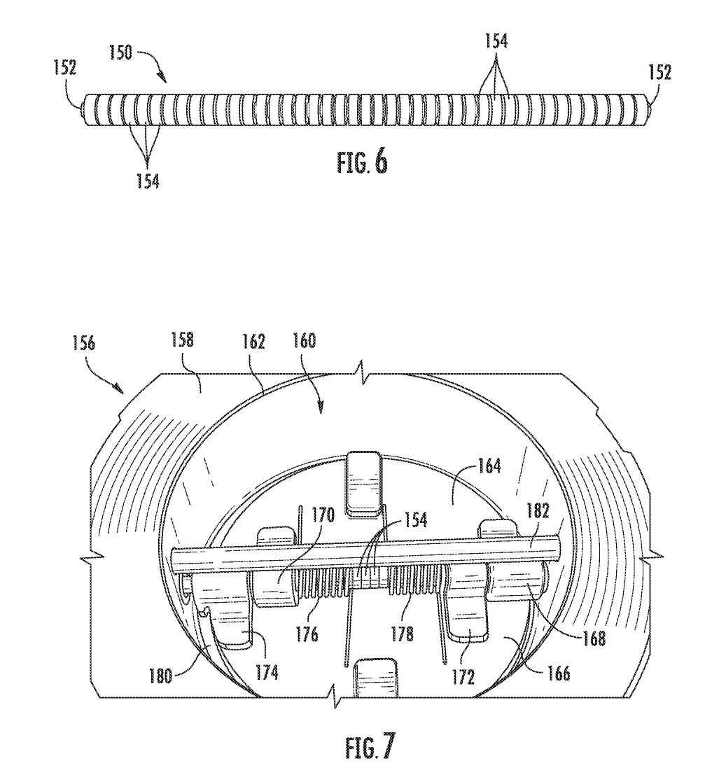

FIG. 6 is a side view of a pivot pin 150 that may be used in a valve constructed in accordance with an embodiment described herein. Pivot pin 150 can comprise a longitudinal shaft 152 which can be fitted with a plurality of bearings 154. In some embodiments, bearings 154 may be fitted or otherwise disposed along substantially the entire length of pivot pin 150 to reduce friction between shaft 152 and the components of a split-disc check valve which rotate about shaft 152, such as valve plates and one or more springs. Thus, as shown, forty-three such bearings 154 may be provided on shaft 152. It will be appreciated, however, that the number and/or size of bearings 154 may vary depending on the application of pivot pin 150, and thus additional or fewer smaller or larger sized bearings 154 may be provided in other embodiments. Bearings 154 may be composite graphite-metal plain bearings, but any suitable type of bearings may be used, including rolling-element bearings, fluid bearings, and bearings formed of materials other than graphite-metal composites.

Those of skill in the art will appreciate that pivot pin 150 may be used in any suitable valve, including other valves employing a pin about which a flap or disc rotates, such as swing check valves. For example, in one preferred embodiment shown in FIG. 7, pivot pin 150 may be used in a split-disc check valve 156. In this regard, check valve 156 may be similar to check valve 100 described above. Thus, check valve 156 may comprise a body 158 defining a flow path 160 between an upstream side and an downstream side 162. Additionally, check valve 156 may comprise a pair of valve plates 164, 166 disposed in flow path 160. Pivot pin 150 may be disposed within or otherwise coupled with body 158 in flow path 160 using any suitable method known to those of skill in the art.

In contrast to prior art check valves which employ dual plates which rotate about a solid metal pin, valve plates 164, 166 may be rotatably coupled with pivot pin 150 having one or more bearings 154. In particular, valve plate 164 may include a pair of mounting arms 168, 170, and valve plate 166 may include a pair of mounting arms 172, 174. Mounting arms 168, 170, 172, 174 can each define an aperture therethrough sized to receive pivot pin 150. In one embodiment, each of mounting arms 168, 170, 172, 174 may be press fit onto one or more bearings 154 such that bearings 154 and valve plates 164, 166 may engage and/or rotate together with respect to shaft 152 of pivot pin 150. In another embodiment, each of mounting arms 168, 170, 172, 174 may simply be sized to fit over bearings 154, where bearings 154 and each of mounting arms 168, 170, 172, 174 may be free to rotate with respect to one another. Also, in the depicted example, a pair of torsion springs 176, 178 may bias valve plates 164, 166 toward the closed position to engage a valve seat 180. Springs 176, 178, which may be analogous to spring 132 described above, may surround at least a portion of pivot pin 150 between mounting arms 168, 170, 172, 174. In the open position (e.g., when force is applied to the valve plates 164, 166 that overcomes the bias of springs 176, 178), valve plates 164, 166 may engage a stop pin 182.

Notably, bearings 154 reduce friction between valve plates 164, 166 and shaft 152 of pivot pin 150, which can reduce wear on these components of check valve 156 that may otherwise be caused by relative movement thereof. Further, because springs 176, 178 are positioned over bearings 154, bearings 154 may also serve to reduce friction between springs 176, 178 and shaft 152 and accordingly reduce wear on springs 176, 178. Notably, pivot pin 150 having bearings 154 may increase the service life of valves in which it is used based on the desirable properties described herein. For example, check valve 156 shown in FIG. 7 has been tested in use to over 10 million cycles. Moreover, pivot pin 150 having bearings 154 allows valve plates 164, 166 to open and close more rapidly than in prior art valves employing a solid metal pin, thereby improving performance of associated valves. Furthermore, embodiments described herein can improve flow performance at lower differential pressures across check valve 156.

It can thus be seen that embodiments described herein provide a pivot pin for valves, such split-disc check valves used in condensate removal systems, which may reduce friction between valve components, reduce wear on the valve, and substantially increase valve service life. While one or more embodiments have been described above, it should be understood that any and all equivalent realizations of the presented embodiments are included within the scope and spirit thereof. The embodiments depicted are presented by way of example only and are not intended as limitations upon the various embodiments that can be implemented or constructed in view of the descriptions. Thus, it should be understood by those of ordinary skill in this art that the present subject matter is not limited to these embodiments since modifications can be made. Therefore, it is contemplated that any and all such embodiments are included in the present subject matter as may fall within the scope and spirit thereof.

What is claimed is:

1. A fluid pump, comprising:
a pump tank having a liquid inlet and a liquid outlet;
at least one check valve in fluid communication with one of said liquid inlet and said liquid outlet;
wherein said at least one check valve comprises a pivot pin, said pivot pin comprising a shaft having a reduced friction bearing arrangement.

2. The fluid pump of claim 1, wherein said reduced friction bearing arrangement comprises one or more bearings configured to rotate at least one valve plate of said at least one check valve about said shaft.

3. The fluid pump of claim 2, wherein a mounting arm of said at least one valve plate defines an aperture that receives at least a portion of said one or more bearings.

4. The fluid pump of claim 2, wherein said one or more bearings comprise a plurality of bearings that are disposed along a substantially entire length of said shaft.

5. The fluid pump of claim 2, wherein said one or more bearings are further configured to rotate at least another valve plate about said shaft, wherein said at least another valve plate is disposed on a diametrically opposing end of said at least one check valve to said at least one valve plate.

6. The fluid pump of claim 2, wherein said one or more bearings comprise composite graphite-metal bearings.

7. The fluid pump of claim 1, wherein said fluid pump is a gas-pressure driven fluid pump.

8. The fluid pump of claim 7, further comprising a float carried within the interior of said pump tank, said float being operative to move between a low level position and a high level position.

9. The fluid pump of claim 8, wherein the float operates a valve control mechanism to control a gas valve assembly of said gas-pressure driven fluid pump.

10. A check valve, comprising:
a body defining a flow path between an upstream side and a downstream side;
a pivot pin disposed within said body in said flow path, said pivot pin comprising a longitudinal shaft and one or more bearings rotatably coupled along at least a portion of said shaft; and
at least one valve plate rotatably coupled with at least one of the one or more bearings to regulate fluid flow through said check valve.

11. The check valve of claim 10, wherein said one or more bearings comprise composite graphite-metal bearings.

12. The check valve of claim 10, wherein said one or more bearings comprise a plurality of bearings disposed along a substantially entire length of said shaft.

13. The check valve of claim 10, wherein said one or more bearings comprise a plurality of bearings disposed such that at least one of said plurality of bearings contacts a mounting arm of said at least one valve plate.

14. The check valve of claim 13, wherein at least another bearing of said plurality of bearings contacts at least another mounting arm of said at least one valve plate.

15. The check valve of claim 14, wherein other bearings of said plurality of bearings contact one or more other mounting arms of another valve plate of said check valve.

16. The check valve of claim 15, wherein said at least one valve plate and said another valve plate are disposed on diametrically opposing ends of said check valve.

17. The check valve of claim 10, wherein a mounting arm of the at least one valve plate defines an aperture that receives at least a portion of the one or more bearings.

18. The check valve of claim 10, further comprising at least one spring coupled with said pivot pin over said plurality of bearings to bias said at least one valve plate toward the closed position.

19. The check valve of claim 18, wherein when said at least one spring biases said at least one valve plate toward the closed position, said at least one valve plate engages at least a portion of said one or more bearings to rotate about said pivot pin toward the closed position.

20. The check valve of claim 18, further comprising at least one stop pin to control rotation of said at least one valve plate about said pivot pin.
